(19) United States
(12) Patent Application Publication
(10) Pub. No.: US 2023/0351485 A1
(43) Pub. Date: Nov. 2, 2023

(54) CENTER APPARATUS, STORE APPARATUS, AND PROCESSING METHOD FOR CENTER APPARATUS

(71) Applicant: NEC Corporation, Minato-ku, Tokyo (JP)

(72) Inventor: Atsuko INOUE, Tokyo (JP)

(73) Assignee: NEC Corporation, Minato-ku, Tokyo (JP)

(21) Appl. No.: 18/026,403

(22) PCT Filed: Sep. 6, 2021
(86) PCT No.: PCT/JP2021/032682

§ 371 Date: Mar. 15, 2023

(30) Foreign Application Priority Data
Sep. 25, 2020 (JP) 2020-160506

(51) Int. Cl. G06Q 30/0601; G09F 3/20; G06Q 20/14

(52) U.S. Cl. CPC G06Q 30/0641; G09F 3/208; G06Q 20/145

(57) ABSTRACT

A center apparatus (10) according to the present invention acquires, from an external terminal (40), authentication information including manufacturer identification information, and in a case where authentication is successful, acquires, from the external terminal (40), control information including information for specifying at least one of display terminals (30) installed in a store, and information for specifying a content to be displayed on the specified display terminal (30). Further, the center apparatus (10) transmits the control information to a predetermined store apparatus (20). The store apparatus (20) causes the display terminal (30) specified by the control information to display a content to be specified by the control information.

### TECHNICAL FIELD

The present invention relates to a display control system, a center apparatus, a store apparatus, a processing method for a center apparatus, a processing method for a store apparatus, and a program.

### BACKGROUND ART

A technique associated with the present invention is disclosed in Patent Documents 1 to 4.

Patent Document 1 discloses a technique in which a printing apparatus introduced in a retail store prints an advertisement medium after updating by using update information transmitted from a manufacturer server. Patent Documents 2 to 4 disclose a technique related to an electronic shelf label.

### RELATED DOCUMENT

### Patent Document

[Patent Document 1] Japanese Patent Application Publication No. 2015-106249
[Patent Document 2] Japanese Patent Application Publication No. 2001-222632
[Patent Document 3] Japanese Patent Application Publication No. 2008-123046
[Patent Document 4] Japanese Patent Application Publication (Translation of PCT Application) No. 2014-519638

### DISCLOSURE OF THE INVENTION

### Technical Problem

An electronic shelf label in recent years becomes a display medium capable of displaying not only a product name and a price, but also various pieces of information. Further, the electronic shelf label is installed for each product. Therefore, a large number of display media capable of displaying various pieces of information are installed in a store. It is desired that such an electronic shelf label is not only simply utilized as a display medium for displaying information determined by a store side, but also utilized more effectively.

An object of the present invention is to provide a technique for effectively utilizing a display terminal such as an electronic shelf label installed in a store by an unconventional method.

### Solution to Problem

The present invention provides a center apparatus including:
an authentication unit that acquires, from an external terminal, authentication information including manufacturer identification information, and performs authentication based on the authentication information;
a control information acquisition unit that, in a case where the authentication is successful, acquires, from the external terminal, control information including display terminal specification information for specifying at least one of display terminals installed in a store, and content information for specifying a content to be displayed on the specified display terminal; and
an output unit that outputs information indicating the control information according to the control information.

Further, the present invention provides a store apparatus including:
a store acquisition unit that acquires, from the center apparatus, control information including display terminal specification information for specifying at least one of display terminals installed in a store, and content information for specifying a content to be displayed on the specified display terminal; and
a display control unit that controls display of the display terminal installed in the store, based on the control information.

Further, the present invention provides a display control system including the center apparatus and the store apparatus.

Further, the present invention provides a processing method for a center apparatus including,
by a center apparatus:
acquiring, from an external terminal, authentication information including manufacturer identification information, and performing authentication based on the authentication information;
in a case where the authentication is successful, acquiring, from the external terminal, control information including display terminal specification information for specifying at least one of display terminals installed in a store, and content information for specifying a content to be displayed on the specified display terminal; and
outputting information indicating the control information according to the control information.

Further, the present invention provides a processing method for a store apparatus including,
by a store apparatus:
acquiring, from the center apparatus, control information including display terminal specification information for specifying at least one of display terminals installed in a store, and content information for specifying a content to be displayed on the specified display terminal; and
controlling display of the display terminal installed in the store, based on the control information.

Further, the present invention provides a program causing a computer in a center apparatus to function as:
an authentication unit that acquires, from an external terminal, authentication information including manufacturer identification information, and performs authentication based on the authentication information;
a control information acquisition unit that, in a case where the authentication is successful, acquires, from the external terminal, control information including display terminal specification information for specifying at least one of display terminals installed in a store, and content information for specifying a content to be displayed on the specified display terminal; and
an output unit that outputs information indicating the control information according to the control information.

Further, the present invention provides a program causing a computer in a store apparatus to function as:
a store acquisition unit that acquires, from the center apparatus, control information including display terminal specification information for specifying at least one of display terminals installed in a store, and content information for specifying a content to be displayed on the specified display terminal; and
a display control unit that controls display of the display terminal installed in the store, based on the control information.

### Advantageous Effects of Invention

The present invention provides a technique for effectively utilizing a display terminal such as an electronic shelf label installed in a store by an unconventional method.

### BRIEF DESCRIPTION OF THE DRAWINGS

FIG. 1 is a diagram illustrating an overall image of a display control system according to a present example embodiment.

FIG. 2 is a diagram illustrating one example of a hardware configuration of an apparatus according to the present example embodiment.

FIG. 3 is one example of a functional block diagram of a center apparatus according to the present example embodiment.

FIG. 4 is a diagram schematically illustrating one example of information to be processed by the display control system according to the present example embodiment.

FIG. 5 is a diagram schematically illustrating one example of information to be processed by the display control system according to the present example embodiment.

FIG. 6 is a diagram schematically illustrating one example of information to be processed by the display control system according to the present example embodiment.

FIG. 7 is a flowchart illustrating one example of a flow of processing of the center apparatus according to the present example embodiment.

FIG. 8 is one example of a functional block diagram of a store apparatus according to the present example embodiment.

FIG. 9 is a diagram illustrating a specific example of processing of the display control system according to the present example embodiment.

FIG. 10 is a flowchart illustrating one example of a flow of processing of the store apparatus according to the present example embodiment.

FIG. 11 is a diagram schematically illustrating one example of information to be processed by the display control system according to the present example embodiment.

FIG. 12 is one example of a functional block diagram of the center apparatus according to the present example embodiment.

### DESCRIPTION OF EMBODIMENTS

Hereinafter, example embodiments according to the present invention are described with reference to the drawings. Note that, in all drawings, a similar constituent element is assigned with a similar reference sign, and description thereof is omitted as necessary.

### First Example Embodiment

### Overview

A display control system according to the present example embodiment is utilized in a retail store utilizing a display terminal such as an electronic shelf label. Further, according to the display control system, a manufacturer of a product (product in sale) handled in a retail store can cause a display terminal installed in a store of the retail store to display desired information. The display control system includes a configuration for achieving an advantageous effect as described above.

### “Overall Image”

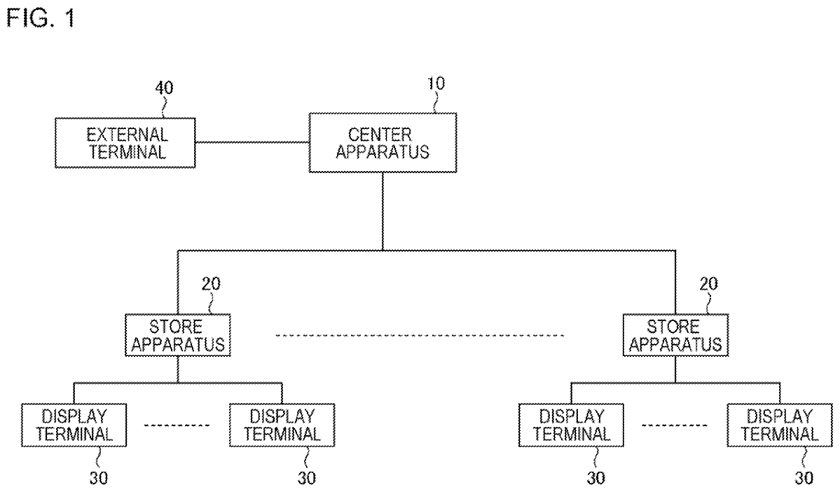

Next, an overall image of the display control system according to the present example embodiment is described with reference to FIG. 1. The display control system includes a center apparatus 10 and a store apparatus 20. The display control system may further include a display terminal 30. Note that, the present example embodiment is based on a premise that the display terminal 30 is an electronic shelf label, but a modification example is described later.

The center apparatus 10 is installed in headquarters that manages a plurality of stores. The store apparatus 20 is installed in each of the plurality of stores. The display terminal 30 is installed in each of the plurality of stores. The display terminal 30 is installed at a predetermined position of a display shelf in association with each product handled in each store. An external terminal 40 is a terminal to be operated by a manufacturer of a product handled in a store.

The center apparatus 10 and each of a plurality of the stores 20 are communicable wiredly and/or wirelessly. Further, the store apparatus 20 installed in each store and each of a plurality of the display terminals 30 are communicable wiredly and/or wirelessly. Furthermore, the center apparatus 10 and the external terminal 40 of each of a plurality of manufacturers are communicable wiredly and/or wirelessly.

An overview of processing to be achieved by these apparatuses is as follows. First, a manufacturer accesses to the center apparatus 10 by operating the external terminal 40, and transmits, to the center apparatus 10, authentication information including manufacturer identification information. Further, after authentication is successful, the manufacturer transmits, to the center apparatus 10 via the external terminal 40, control information including display terminal specification information for specifying at least one of the display terminals 30 installed in a store, and content information for specifying a content to be displayed on the specified display terminal 30.

The center apparatus 10 receives the above-described control information transmitted by the manufacturer in which authentication is successful and having legitimate authority. Further, the center apparatus 10 transmits the received control information to a predetermined store apparatus 20. The store apparatus 20 that has received the control information causes the predetermined display terminal 30 to display a predetermined content, based on the control information.

### “Hardware Configuration”

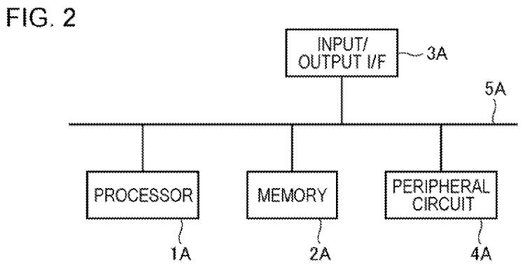

Next, one example of a hardware configuration of the center apparatus 10 and the store apparatus 20 is described. FIG. 2 is a diagram illustrating a hardware configuration example of the center apparatus 10 and the store apparatus 20. Each functional unit included in the center apparatus 10 and the store apparatus 20 is achieved by any combination of hardware and software mainly including a central processing unit (CPU) of any computer, a memory, a program loaded in a memory, a storage unit (capable of storing, in addition to a program stored in advance at a shipping stage of an apparatus, a program downloaded from a storage medium such as a compact disc (CD), a server on the Internet, and the like) such as a hard disk storing the program, and an interface for network connection. Further, it is understood by a person skilled in the art that there are various modification examples as a method and an apparatus for achieving the configuration.

As illustrated in FIG. 2, each of the center apparatus 10 and the store apparatus 20 includes a processor 1A, a memory 2A, an input/output interface 3A, a peripheral circuit 4A, and a bus 5A. The peripheral circuit 4A includes various modules. At least one of the center apparatus 10 and the store apparatus 20 may not include the peripheral circuit 4A.

Note that, each of the center apparatus 10 and the store apparatus 20 may be constituted of a plurality of apparatuses that are physically and/or logically separated, or may be constituted of one apparatus that is physically and/or logically integrated. In the former case, each apparatus can include the above-described hardware configuration.

The bus 5A is a data transmission path along which the processor 1A, the memory 2A, the peripheral circuit 4A, and the input/output interface 3A mutually transmit and receive data. The processor 1A is, for example, an arithmetic processing apparatus such as a CPU and a graphics processing unit (GPU). The memory 2A is, for example, a memory such as a random access memory (RAM) and a read only memory (ROM). The input/output interface 3A includes an interface for acquiring information from an input apparatus, an external apparatus, an external server, an external sensor, and the like, an interface for outputting information to an output apparatus, an external apparatus, an external server, and the like, and the like. The input apparatus is, for example, a keyboard, a mouse, a microphone, and the like. The output apparatus is, for example, a display, a speaker, a printer, a mailer, and the like. The processor 1A can issue a command to each module, and perform arithmetic operation, based on these arithmetic operation results.

### “Functional Configuration”

### —Center Apparatus 10—

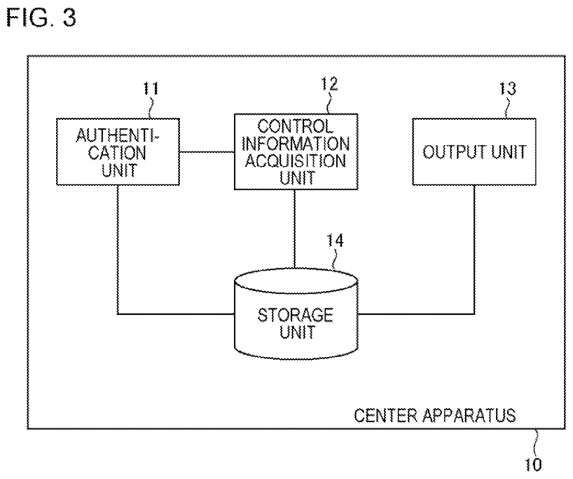

As illustrated by a functional block diagram in FIG. 3, the center apparatus 10 includes an authentication unit 11, a control information acquisition unit 12, an output unit 13, and a storage unit 14. Note that, the center apparatus 10 may not include the storage unit 14. In this case, an external apparatus configured to be communicable with the center apparatus 10 includes the storage unit 14.

The authentication unit 11 acquires, from the external terminal 40, authentication information including manufacturer identification information, and performs authentication based on the authentication information. For authentication processing to be performed by the authentication unit 11, any conventional authentication technique can be adopted.

For example, the center apparatus 10 provides the external terminal 40 accessed via a communication network with a login page. The external terminal 40 displays the login page on a display of an own terminal, and accepts, on the login page, an input of authentication information including manufacturer identification information. Further, the external terminal 40 transmits the input authentication information to the center apparatus 10. The center apparatus 10 performs authentication processing by collating the received authentication information with reference information (authentication information of each manufacturer) stored in advance in the storage unit 14.

The manufacturer identification information is information for identifying a plurality of manufactures from one another. The authentication information may include, in addition to the manufacturer identification information, a password, a one-time password, biological information (such as face information, fingerprint information, iris information, and voiceprint information) of a person in charge of a manufacturer, a keyword, and the like.

In a case where authentication by the authentication unit 11 is successful, the control information acquisition unit 12 acquires, from the external terminal 40, control information for controlling display of the display terminal 30 installed in a store.

For example, after authentication by the authentication unit 11 is successful, the center apparatus 10 provides the external terminal 40 with a user page for inputting control information. The external terminal 40 displays the page on a display of the own terminal, and accepts an input of control information on the page. Further, the external terminal 40 transmits the input control information to the center apparatus 10.

The control information includes at least one of pieces of store specification information, pieces of display terminal specification information, pieces of content information, and a display condition.

The “store specification information” is information for specifying a store being a target of display control for the display terminal 30. At least one of a plurality of stores is specified by the store specification information. In a case where control information does not include store specification information as described above, all stores may be specified as a target of display control for the display terminal 30. Hereinafter, examples of store specification are described.

### —Store Specification Example 1—

The store specification information may be, for example, information for specifying a desired store by store identification information such as a store name. In this case, a manufacturer inputs, to the external terminal 40, store identification information of a desired store, as store specification information.

### Store Specification Example 2

In addition, the store specification information may be information for specifying a desired store by a store attribute. Examples of the store attribute are a location of a store, a surrounding environment of a store, a product handled in a store, a mode of operation (a store directly managed by headquarters/a franchise store), and the like, but is not limited thereto.

In this case, a manufacturer inputs, to the external terminal 40, a desired store attribute, as store specification information. Further, the center apparatus 10 searches a store corresponding to the specified store attribute, based on store information generated in advance, and determines the searched store, as a target of display control for the display terminal 30. The above-described store information is information indicating a store attribute of each of a plurality of stores, and is stored in the storage unit 14 and/or a storage unit 23 of each store apparatus 20.

Examples of specification of a store attribute by a manufacturer include a condition such as “a store whose location is in Tokyo”, “a store being present within 100 m from a station”, “a store handling a product A”, and “a store directly managed by headquarters”, a condition in which a plurality of conditions as described above are linked by a predetermined logical operator, and the like. Note that, this example is merely one example, and is not limited thereto.

### —Store Specification Example 3—

In addition, the store specification information may be information for specifying all stores. In this case, as the store specification information, a manufacturer performs an input of specifying all stores with respect to the external terminal 40.

The “display terminal specification information” is information for specifying the display terminal 30 being a target of display control. At least one of a plurality of display terminals 30 installed in a store is specified by the display terminal specification information. In a case where control information does not include display terminal specification information as described above, all display terminals 30, or all display terminals 30 associated with a product of each manufacturer may be specified as a target of display control. Note that, an input of display terminal specification information by a manufacturer may be performed for each store, or may be performed altogether for a plurality of stores. Hereinafter, examples of display terminal specification are described.

### —Display Terminal Specification Example 1—

The display terminal specification information may include, for example, as information for specifying a display terminal 30, information (product identification information such as a product name and a product code) for identifying an associated product. In a store, a plurality of display terminals 30 are installed in association with each of a plurality of products, and information (such as a product name and a unit price) on the associated product is displayed on each display terminal 30 associated with each product. Therefore, it is possible to specify the display terminal 30 by product identification information.

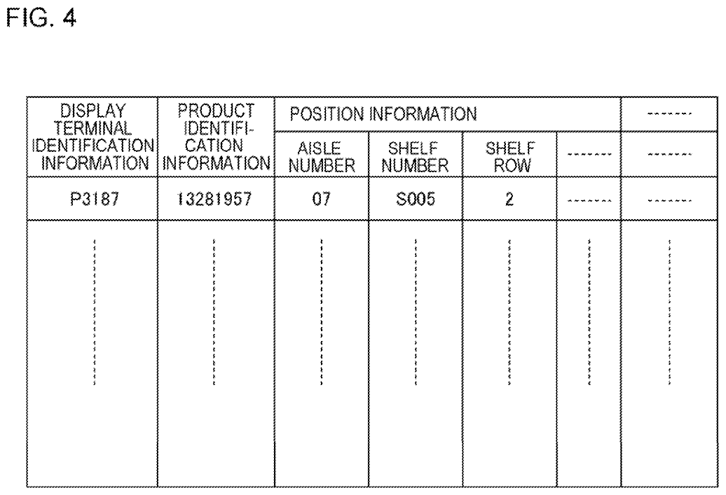

In this case, a manufacturer inputs, to the external terminal 40, desired product identification information, as display terminal specification information. Further, at least one of the center apparatus 10 and the store apparatus 20 determines, as a target of display control, a display terminal 30 associated with the display terminal specification information (product identification information), based on display terminal attribute information generated in advance. The above-described display terminal attribute information is, as illustrated in FIG. 4, information indicating a correlation between each of a plurality of display terminals 30 and a product, and is stored in the storage unit 14 and/or the storage unit 23 of each store apparatus 20. The display terminal attribute information is generated for each store. The display terminal attribute information illustrated in FIG. 4 associates display terminal identification information and product identification information with each other.

### —Display Terminal Specification Example 2—

In addition, the display terminal specification information may include, as information for specifying a display terminal 30, information indicating an installation position within a store. In this case, a manufacturer inputs, to the external terminal 40, a desired installation position, as the display terminal specification information. Further, at least one of the center apparatus 10 and the store apparatus 20 determines, as a target of display control, a display terminal 30 that matches the display terminal specification information (installation position), based on display terminal attribute information generated in advance. The above-described display terminal attribute information is, as illustrated in FIG. 4, information indicating an installation position of each of a plurality of display terminals 30, and is stored in the storage unit 14 and/or the storage unit 23 of each store apparatus 20. The display terminal attribute information is generated for each store. The display terminal attribute information illustrated in FIG. 4 associates display terminal identification information and position information indicating an installation position of each display terminal 30 with each other.

In a case of the illustrated example, an installation position of a display terminal 30 is indicated by an aisle number, a shelf number, a shelf row, and the like, but may be indicated by another method. Although not illustrated, information indicating an attribute (such as in front of a cash register, near an entrance, or an aisle connected to a cash register) of each display shelf or each aisle may be included.

Examples of specification of an installation position by a manufacturer include a condition such as “a display area at a second row from a top of a display shelf”, “a display area facing an aisle connected to a cash register”, “a display shelf in front of a cash register”, and “a display shelf near an entrance”, a condition in which a plurality of conditions as described above are linked by a predetermined logical operator, and the like. Note that, this example is merely one example, and is not limited thereto.

### —Display Terminal Specification Example 3—

Further, the center apparatus 10 may transmit, to the external terminal 40, an image indicating an in-store layout (indicating a layout of display shelves) of each store, and cause the external terminal 40 to display the image. Further, a manufacturer may perform, on the in-store layout, an input of specifying a desired installation position (such as an input of specifying a display shelf, or an input of specifying a row).

### —Display Terminal Specification Example 4—

Note that, each manufacturer may specify only a display terminal 30 associated with a product of each manufacturer. Specifically, display terminal specification information to be input by each manufacturer may be information for specifying at least one of display terminals 30 associated with a product of each manufacturer. In this case, the control information acquisition unit 12 determines whether display terminal specification information acquired by any of the above-described display terminal specification examples 1 to 3 satisfies the condition. Further, in a case where the condition is not satisfied, the control information acquisition unit 12 replies error information to the external terminal 40.

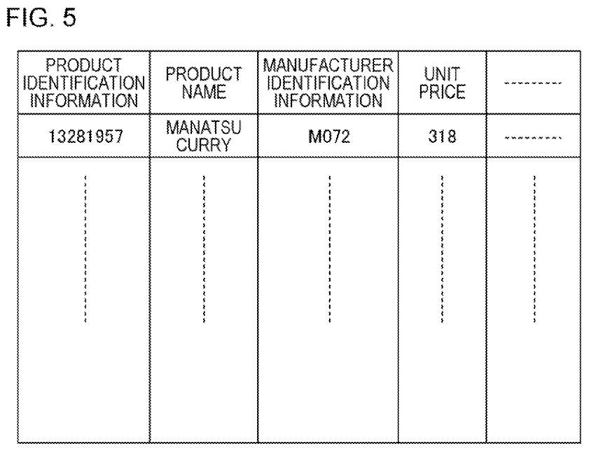

For example, in a case where product identification information is acquired as display terminal specification information, the control information acquisition unit 12 determines whether a product identified by the acquired product identification information is a product of the manufacturer, based on product information (see FIG. 5) stored in advance in the storage unit 14 and/or the storage unit 23 of each store apparatus 20. Further, in a case where a product identified by the acquired product identification information is not a product of the manufacturer, the control information acquisition unit 12 replies error information to the external terminal 40. In the product information illustrated in FIG. 5, product identification information, a product name, manufacturer identification, and a unit price are associated with one another.

In addition, for example, in a case where information indicating an installation position within a store is acquired as display terminal specification information, the control information acquisition unit 12 determines whether a product of the manufacturer is displayed at a position specified by the acquired display terminal specification information, based on the above-described display terminal attribute information (see FIG. 4) and product information (see FIG. 5). Further, in a case where the product of the manufacturer is not displayed at the position specified by the acquired display terminal specification information, the control information acquisition unit 12 replies error information to the external terminal 40.

### —Display Terminal Specification Example 5—

Note that, the display terminal specification information to be input by a manufacturer may be information for specifying all display terminals 30 associated with a product of each manufacturer. In this case, a manufacturer performs, with respect to the external terminal 40, an input of specifying all display terminals 30 associated with a product of the own manufacturer, as display terminal specification information.

The “content information” is information for specifying a content to be displayed on a display terminal 30 specified as a target of display control. The content is, for example, an advertisement, campaign information, a coupon, product associated information, and the like. The product associated information may include a URL of a webpage (such as a product introduction page) associated with a product prepared by a manufacturer. The URL may be displayed by a QR code (registered trademark). Note that, a content of the product A may be displayed not only on a display terminal 30 associated with the product A, but also on a display terminal 30 associated with another product.

Note that, an input of content information by a manufacturer may be performed for each store, or may be performed altogether for a plurality of stores. Further, an input of content information by a manufacturer may be performed for each display terminal 30 specified as a target of display control, or may be performed altogether for a plurality of display terminals 30.

Hereinafter, examples of content specification are described.

### —Content Specification Example 1—

The content information may be a file (such as a still image file, a moving image file, and an audio file) itself of a content. In this case, a manufacturer prepares (generates) a content by itself, and transmits (uploads), as content information, from the external terminal 40 to the center apparatus 10.

### —Content Specification Example 2—

In addition, the content information may be information (such as a file name) for specifying any of files of contents stored in advance in the storage unit 14. In this case, a manufacturer may transmit (upload) in advance, from the external terminal 40 to the center apparatus 10, a file (such as a still image file, a moving image file, and an audio file) of a content prepared (generated) by itself, and register the file in the storage unit 14. In addition, a file of a content previously transmitted to the center apparatus 10, as content information, may be stored in the storage unit 14 as it is. A manufacturer specifies, for example, any of files of contents stored in advance in the storage unit 14 as described above.

The “display condition” is a condition (hereinafter, referred to as a “display condition”) for displaying a content specified by content information on a display terminal 30 specified as a target of display control. The content is displayed on the display terminal 30 at a timing that matches the display condition.

Note that, an input of a display condition by a manufacturer may be performed for each store, or may be performed altogether for a plurality of stores. Further, an input of a display condition by a manufacturer may be performed for each display terminal 30 specified as a target of display control, or may be performed altogether for a plurality of display terminals 30.

For example, as the display condition, a period during which a content is displayed may be specified such as “from March 1”, 2020 to Mar. 14, 2020″.

In addition, as the display condition, a day of a week when a content is displayed may be specified.

In addition, as the display condition, a time period during which a content is displayed may be specified such as “from 11:00 to 17:00”.

In addition, as the display condition, a weather, a temperature, a congestion status of a store, and the like of a day when a content is displayed may be specified.

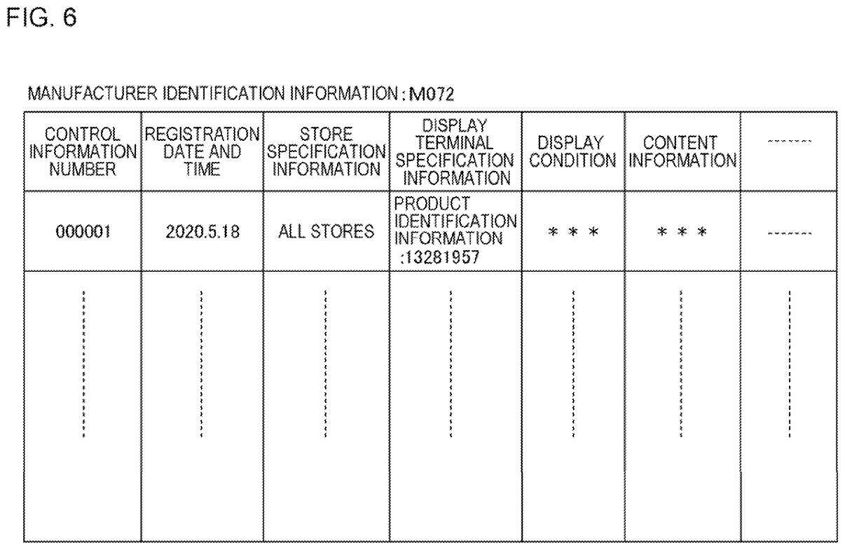

The control information acquisition unit 12 may store acquired control information altogether for each manufacturer in the storage unit 14. FIG. 6 schematically illustrates one example of control information registered in the storage unit 14. In the illustrated example, a control information number for identifying pieces of acquired control information from each other, a registration date and time indicating a date and time when each piece of control information is registered in the center apparatus 10, store specification information, display terminal specification information, a display condition, and content information are associated with one another.

Referring back to FIG. 3, the output unit 13 outputs information indicating control information to the store apparatus 20 according to control information. For example, the output unit 13 transmits control information to the store apparatus 20 in a store to be specified by store specification information included in the control information.

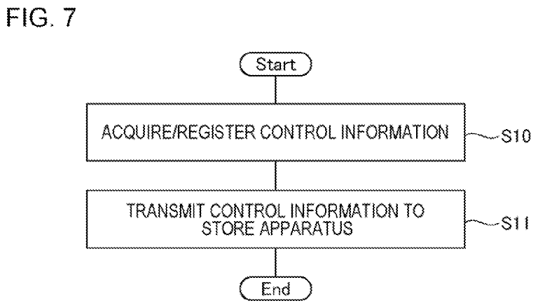

Next, one example of a flow of processing to be performed by the center apparatus 10 is described with reference to a flowchart in FIG. 7. As illustrated in FIG. 7, when the center apparatus 10 acquires control information from the external terminal 40, and registers the control information in the storage unit 14 (S10), the center apparatus 10 transmits the control information to the store apparatus 20 (S11). Note that, the center apparatus 10 may perform processing of S11 in real-time in response to acquisition of control information from the external terminal 40 and registration of the control information in the storage unit 14. In addition, processing of S11 may be performed at a predetermined time interval. In this case, the center apparatus 10 may transmit control information being registered in the storage unit 14 from a previous transmission timing until a current-time transmission timing altogether to the store apparatus 20.

### —Store Apparatus 20—

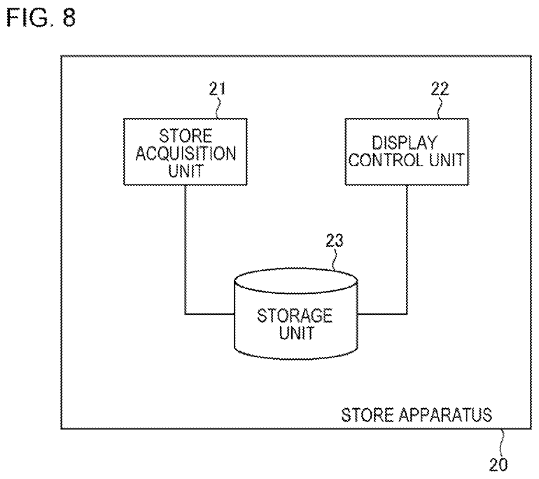

As illustrated in a functional block diagram in FIG. 8, the store apparatus 20 includes a store acquisition unit 21, a display control unit 22, and the storage unit 23. Note that, the store apparatus 20 may not include the storage unit 23. In this case, an external apparatus configured to be communicable with the store apparatus 20 includes the storage unit 23.

The store acquisition unit 21 acquires control information from the center apparatus 10. Further, the store acquisition unit 21 acquires, from the center apparatus 10, a file of a content to be specified by content information included in the acquired control information. Note that, the store apparatus 20 may acquire, from the center apparatus 10, only a file of a content to be specified by the content information, or may acquire all files of contents stored in the storage unit 14 of the center apparatus 10.

The display control unit 22 controls display of a display terminal 30 installed in a store, based on control information. Specifically, the display control unit 22 causes a display terminal 30 to be specified by display terminal specification information included in control information to display a content to be specified by content information included in the control information. Further, the display control unit 22 causes to display a content to be specified by the content information at a timing that matches a display condition included in the control information.

Note that, in a case where a plurality of contents to be displayed on one display terminal 30 are present, the display control unit 22 can determine a content to be displayed on the display terminal 30, based on a priority being determined in advance. A specific example of the processing is described. Note that, the specific example is merely one example, and is not limited thereto.

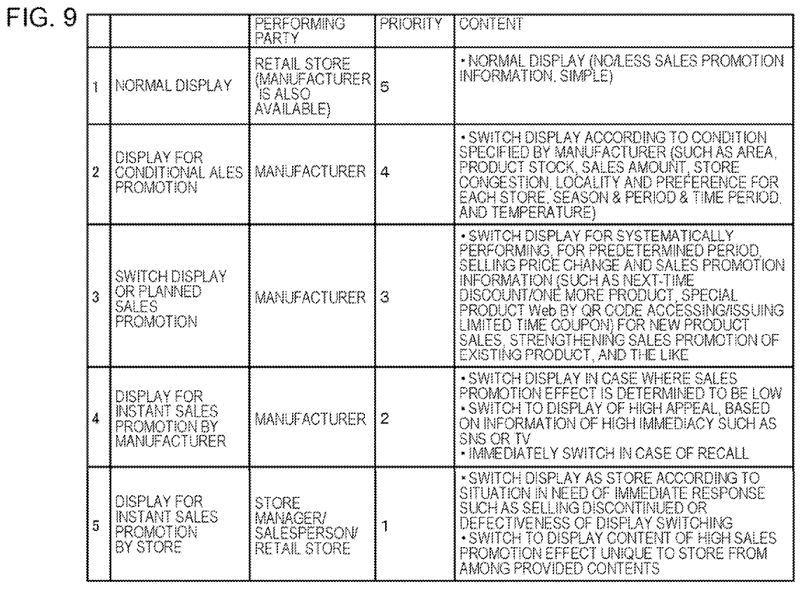

In the specific example, control of a display terminal 30 is classified into five patterns illustrated in FIG. 9.
“1. Normal display” is a control pattern at a normal time when manufacturer control or temporary control is not present. Determination of a content at the control time is performed by headquarters of a retail store. Note that, a manufacturer of each product may determine a content at the control time. At the control time, for example, a relatively simple content including a product name, a unit price, simple pop information, and the like of each product, and in which there is no or less sales promotion information is displayed. In a case where there is no control based on another control pattern, a content is displayed on a display terminal 30 with a control pattern at the normal time.
“2. Display for conditional sales promotion” is one pattern of manufacturer control. A manufacturer specifies a relatively long period, and performs the control. Determination of a content at the control time is performed by a manufacturer. A manufacturer sets various display conditions as illustrated in FIG. 9, for example, and performs the control.
“3. Switch display for planned sales promotion” is one pattern of manufacturer control. A manufacturer specifies a relatively short period, and performs the control. Determination of a content at the control time is performed by a manufacturer. A manufacturer sets various display conditions as illustrated in FIG. 9, for example, and performs the control.
“4. Display for instant sales promotion by manufacturer” is one pattern of manufacturer control. The control is control of instantaneously changing a content displayed on a display terminal 30 by a manufacturer. Determination of a content at the control time is performed by a manufacturer. A manufacturer performs control of instantaneously changing a content displayed on a display terminal 30, based on a reason as illustrated in FIG. 9, for example.
“5. Display for instant sales promotion by store” is control of instantaneously changing a content displayed on a display terminal 30 by a store manager or a salesperson at each store, or headquarters of a retail store. For example, in control information, a plurality of choices may be specified as a content to be displayed on each display terminal 30. Further, a store manager or a salesperson at each store, or headquarters of a retail store may be allowed to specify and display any of the choices, or change a content during display to another content (choice). Furthermore, a store manager or a salesperson at each store, or headquarters of a retail store may change a content of a certain control pattern during display to a content of another control pattern. An input of these pieces of control by a store manager or a salesperson, or headquarters of a retail store may be performed via an input apparatus of the store apparatus 20, may be performed via a display terminal 30, or may be performed via another apparatus.

Further, as illustrated in FIG. 9, in the example, a priority is given to the five control patterns. In a case where contents of a plurality of control patterns are present, as a content to be displayed on one display terminal 30, the display control unit 22 causes to display a content of a control pattern having a higher priority at the time.

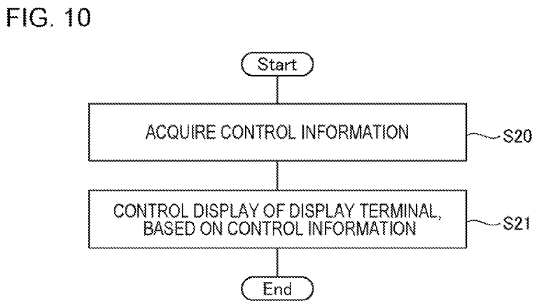

Next, one example of a flow of processing to be performed by the store apparatus 20 is described with reference to a flowchart in FIG. 10. As illustrated in FIG. 10, when the store apparatus 20 acquires control information from the center apparatus 10 (S20), the store apparatus 20 controls display of a display terminal 30, based on the control information (S21).

### “Advantageous Effect”

The display control system according to the present example embodiment allows a manufacturer of a product (product in sale) handled in a retail store to display desired information on a display terminal 30 installed in a store of the retail store. Consequently, it becomes possible to effectively utilize a display terminal 30 installed in a store by an unconventional method.

### Second Example Embodiment

A store apparatus 20 according to the present example embodiment includes a function of notifying a store manager or a salesperson of a display terminal 30 that performs display of a content based on control information. For example, the store apparatus 20 may cause the display terminal 30 that performs display of a content based on control information to perform an output indicating the above. For example, the store apparatus 20 may turn on or blink a light included in the display terminal 30, or turn on/blink with a predetermined color.

In addition, the store apparatus 20 may cause another output apparatus to display a list of display terminals 30 that perform display of a content based on control information. Further, the store apparatus 20 may cause another output apparatus to display, at a timing at which display of a content based on control information is started, information (such as a position of a display terminal 30, identification information of an associated product, and a manufacturer name) related to the display terminal 30 that has started display of the content. Further, the store apparatus 20 may cause another output apparatus to display, at a timing at which display of a content based on control information is finished, information (such as a position of a display terminal 30, identification information of an associated product, and a manufacturer name) related to the display terminal 30 that has finished display of the content.

Examples of the another output apparatus include a point of sales (POS) cash register installed in a store, a computer installed in a store, and the like. These apparatuses and the store apparatus 20 are configured to be communicable wiredly and/or wirelessly. The another output apparatus may be a portable apparatus such as a smartphone, a tablet terminal, a mobile phone, and a smartwatch. Further, the store apparatus 20 may transmit the above-described information to these apparatuses by utilizing an electronic mail, an application, and the like.

Other configurations of a display control system are similar to those of the first example embodiment.

The display control system according to the present example embodiment achieves an advantageous effect similar to that of the first example embodiment. Further, the display control system according to the present example embodiment allows a store manager or a salesperson to recognize which display terminal 30 displays a content according to manufacturer control.

### Third Example Embodiment

In a display control system according to the present example embodiment, a manufacturer can change a unit price of an own product, and cause a display terminal 30 to display the unit price after the change. After specifying a store, and specifying a product (specifying a display terminal 30) in a similar manner to input of control information, the manufacturer further specifies a unit price of the specified product, and transmits, to a center apparatus 10, control information indicating these items. The center apparatus 10 transmits the control information to a store apparatus 20 in the specified store.

The store apparatus 20 updates a product master stored in a storage unit 23, based on the received control information. Specifically, the store apparatus 20 changes a unit price of a product specified by the received control information to a unit price specified by the received control information. Further, the store apparatus 20 changes the unit price displayed on the display terminal 30 associated with the product to the unit price after the change.

Other configurations of the display control system are similar to those of the first and second example embodiments.

The display control system according to the present example embodiment achieves an advantageous effect similar to that of the first and second example embodiments. Further, the display control system according to the present example embodiment allows a manufacturer to freely set a unit price of an own product.

### Fourth Example Embodiment

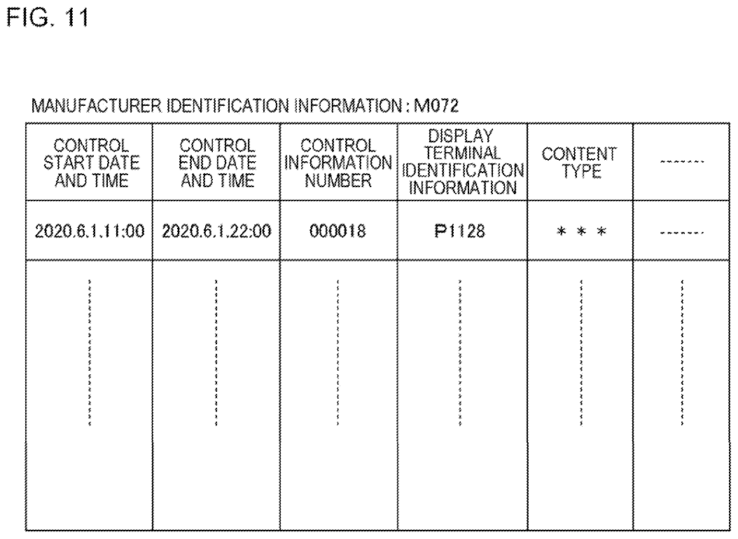

A store apparatus 20 according to the present example embodiment allows a storage unit 23 to store history information indicating a history according to which display of a display terminal 30 has been controlled based on control information altogether for each manufacturer. FIG. 11 illustrates one example of the history information. In the illustrated example, a date and time (control start date and time) when display control (display of a content) of a display terminal 30 based on control information is started, a date and time (control end date and time) when the display control is finished, a control information number for identifying the control information, display terminal identification information for identifying the display terminal 30 that has controlled the display, and a content type indicating a type of a displayed content are associated with one another.

The content type may be classification according to a content of contents such as an advertisement, campaign information, product associated information, and a unit price change. In addition, the content type may indicate a control pattern described with reference to FIG. 9.

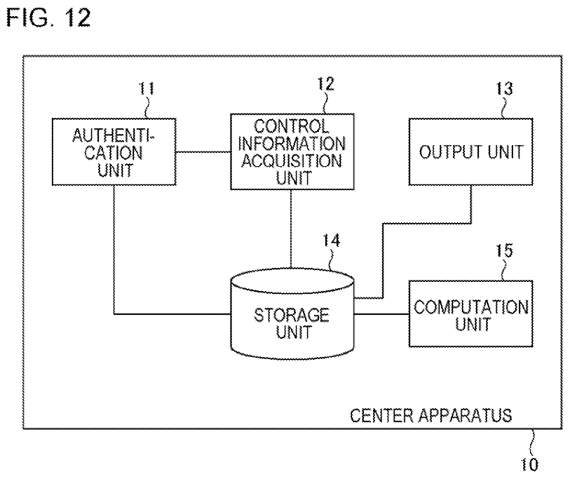

Further, as illustrated in FIG. 12, a center apparatus 10 according to the present example embodiment further includes a computation unit 15. The computation unit 15 computes a usage fee of a display terminal 30 to be charged to a manufacturer, based on a display control content of the display terminal 30 based on control information. The manufacturer pays the usage fee computed herein to a retail store, as compensation for usage of the display terminal 30. The computation unit 15 can compute the usage fee, for example, based on history information illustrated in FIG. 11.

Note that, the computation unit 15 may compute the usage fee, based on the number of used display terminals 30. In this case, as the number of display terminals increases, the usage fee increases. In addition, the computation unit 15 may compute the usage fee, based on a control time (display time of a content) of a display terminal 30. In this case, as the control time extends, the usage fee increases. A fee per number of display terminals, or a fee per time period may be according to a type of a displayed content. Further, a fee per number of display terminals, or a fee per time period may be different for each display terminal 30 depending on an installation position of a display terminal 30. For example, it is possible to increase a fee per number of display terminals or a fee per time period for a display terminal 30 being installed at a position easily recognizable by a customer, such as in front of a cash register, near an entrance, or a height of an eye level of a person.

In addition, the computation unit 15 may compute the usage fee, based on an advantageous effect achieved by control of a display terminal 30. For example, an index (such as an increment or an increase rate) indicating how much sales performance has increased from a normal time may be computed, based on sales performance (such as a sales amount per unit time, the number of sales, and a profit rate) at a normal time, and sales performance when manufacturer control of the display terminal 30 is performed. Further, the computation unit 15 may compute the usage fee, based on the index. In this case, the usage fee increases, as an advantageous effect achieved by control of the display terminal 30 becomes more satisfactory (as an increment or an increase rate increases).

In addition, in a case where a unit price of a product is changed by control information, the computation unit 15 may compute the usage fee, based on a difference in a unit price between before and after the change. For example, the computation unit 15 may compute, as the usage fee, a value acquired by multiplying the difference by the number of products sold during the time.

Further, the computation unit 15 may compute the usage fee, based on the number of accesses to a manufacturer site from a QR code (registered trademark) displayed on a display terminal 30 by manufacturer control. In this case, as the number of accesses increases, the usage fee increases. Note that, a unit for recognizing the number of accesses to a predetermined site is not specifically limited, and any technique can be adopted.

Further, the computation unit 15 may compute the usage fee, based on a product purchase record from the manufacturer site. In this case, as a purchase record (such as the number of purchases, a purchase amount, and a profit) increases, the usage fee increases.

Further, the computation unit 15 may compute the usage fee, based on a usage status of a coupon displayed on a display terminal 30 by manufacturer control. In this case, as a frequency of usage (such as the number of times of usage) of the coupon increases, the usage fee increases.

Other configurations of the display control system are similar to those of the first to third example embodiments.

The display control system according to the present example embodiment achieves an advantageous effect similar to that of the first to third example embodiments. Further, the display control system according to the present example embodiment enables to compute compensation (usage fee) for usage of s display terminal 30 by a manufacturer. By acquiring the usage fee from a manufacturer by a retail store, usage of a display terminal 30 by the manufacturer allows both the manufacturer and the retail store to acquire a profit.

### Modification Example

Herein, a modification example applicable to all the example embodiments is described. The above-described example embodiments are based on a premise that a display terminal 30 installed in a store is an electronic shelf label. As a modification example, the display terminal 30 may be an apparatus other than an electronic shelf label, for example, a digital shelf (such as a shelf label, or a display terminal in a store). Further, the display terminal 30 may include an electronic shelf label, and an apparatus other than the electronic shelf label. Also in the modification example, a similar advantageous effect is achieved by similar processing to that of the above-described example embodiments.

Further, in the above-described example embodiments, a center apparatus 10 transmits control information to a store apparatus 20, and the store apparatus 20 controls display of a predetermined display terminal 30, based on the control information. As a modification example, the center apparatus 10 may control display of a predetermined display terminal 30, based on control information without the store apparatus 20. Specifically, the center apparatus 10 may transmit a file of a content to a display terminal 30 without the store apparatus 20. Further, an output unit 13 of the center apparatus 10 may include a function of a display control unit 22 of the above-described store apparatus 20.

As described above, while the example embodiments according to the present invention have been described with reference to the drawings, these example embodiments are an example of the present invention, and various configurations other than the above can also be adopted.

Note that, in the present description, “acquisition” includes at least one of “acquisition of data stored in another apparatus or a storage medium by an own apparatus (active acquisition)”, based on a user input, or based on a command of a program, for example, requesting or inquiring another apparatus and receiving, accessing to another apparatus or a storage medium and reading, and the like, “input of data to be output from another apparatus to an own apparatus (passive acquisition)”, based on a user input, or based on a command of a program, for example, receiving data to be distributed (or transmitted, push-notified, or the like), and acquiring by selecting from received data or information, and “generating new data by editing data (such as converting into a text, rearranging data, extracting a part of pieces of data, and changing a file format) and the like, and acquiring the new data”.

A part or all of the above-described example embodiments may also be described as the following supplementary notes, but is not limited to the following.
1. A center apparatus including:
   an authentication unit that acquires, from an external terminal, authentication information including manufacturer identification information, and performs authentication based on the authentication information;
   a control information acquisition unit that, in a case where the authentication is successful, acquires, from the external terminal, control information including display terminal specification information for specifying at least one of display terminals installed in a store, and content information for specifying a content to be displayed on the specified display terminal; and
   an output unit that outputs information indicating the control information according to the control information.
2. The center apparatus according to supplementary note 1, wherein the control information acquisition unit acquires the control information further including store specification information for specifying the store in which the content is displayed.
3. The center apparatus according to supplementary note 1 or 2, wherein the control information acquisition unit acquires the control information further including a display condition in which the content is displayed on the display terminal specified by the display terminal specification information.
4. The center apparatus according to any one of supplementary notes 1 to 3, wherein
   the display terminal is an electronic shelf label,
   a plurality of the electronic shelf labels are installed in association with each of a plurality of products in the store, and
   the display terminal specification information includes, as information for specifying the display terminal, information for identifying the associated product.
5. The center apparatus according to any one of supplementary notes 1 to 4, wherein the display terminal specification information includes, as information for specifying the display terminal, information indicating an installation position in the store.
6. The center apparatus according to any one of supplementary notes 1 to 6, wherein
   the display terminal is an electronic shelf label,
   a plurality of the electronic shelf labels are installed in association with each of a plurality of products in the store, and
   the display terminal specification information to be input by each manufacturer is information for specifying at least one of the display terminals associated with the product of each manufacturer.
7. The center apparatus according to any one of supplementary notes 1 to 6, further including a computation unit that computes a usage fee of the display terminal to be charged to a manufacturer according to a display control content of the display terminal based on the control information.
8. A store apparatus including:
   a store acquisition unit that acquires, from the center apparatus according to any one of supplementary note 1 to 7, control information including display terminal specification information for specifying at least one of display terminals installed in a store, and content information for specifying a content to be displayed on the specified display terminal; and
   a display control unit that controls display of the display terminal installed in the store, based on the control information.
9. The store apparatus according to supplementary note 8, wherein,
   in a case where a plurality of contents to be displayed on the one display terminal are present, the display control unit determines a content to be displayed on the display terminal, based on a priority being determined in advance.
10. A display control system including:
   the center apparatus according to any one of supplementary notes 1 to 7; and
   the store apparatus according to supplementary note 8 or 9.
11. A processing method for a center apparatus, including, by a center apparatus:
   acquiring, from an external terminal, authentication information including manufacturer identification information, and performing authentication based on the authentication information;
   in a case where the authentication is successful, acquiring, from the external terminal, control information including display terminal specification information for specifying at least one of display terminals installed in a store, and content information for specifying a content to be displayed on the specified display terminal; and
   outputting information indicating the control information according to the control information.
12. A processing method for a store apparatus, including,
   by a store apparatus:
   acquiring, from the center apparatus according to any one of supplementary notes 1 to 7, control information including display terminal specification information for specifying at least one of display terminals installed in a store, and content information for specifying a content to be displayed on the specified display terminal; and
   controlling display of the display terminal installed in the store, based on the control information.
13. A program causing a computer in a center apparatus to function as:
   an authentication unit that acquires, from an external terminal, authentication information including manufacturer identification information, and performs authentication based on the authentication information;
   a control information acquisition unit that, in a case where the authentication is successful, acquires, from the external terminal, control information including display terminal specification information for specifying at least one of display terminals installed in a store, and content information for specifying a content to be displayed on the specified display terminal; and
   an output unit that outputs information indicating the control information according to the control information.
14. A program causing a computer in a store apparatus to function as:
   a store acquisition unit that acquires, from the center apparatus according to any one of supplementary notes 1 to 7, control information including display terminal specification information for specifying at least one of display terminals installed in a store, and content information for specifying a content to be displayed on the specified display terminal; and
   a display control unit that controls display of the display terminal installed in the store, based on the control information.

This application is based upon and claims the benefit of priority from Japanese patent application No. 2020-160506, filed on Sep. 25, 2020, the disclosure of which is incorporated herein in its entirety by reference.

### REFERENCE SIGNS LIST

Center apparatus
11 Authentication unit
12 Control information acquisition unit
13 Output unit
14 Storage unit
15 Computation unit
20 Store apparatus
21 Store acquisition unit
22 Display control unit
23 Storage unit
30 Display terminal
40 External terminal

What is claimed is:

1. A center apparatus comprising:
at least one memory configured to store one or more instructions; and
at least one processor configured to execute the one or more instructions to:
acquire, from an external terminal, authentication information including manufacturer identification information, and perform authentication based on the authentication information;
in a case where the authentication is successful, acquire, from the external terminal, control information including display terminal specification information for specifying at least one of display terminals installed in a store, and content information for specifying a content to be displayed on the specified display terminal; and
output information indicating the control information according to the control information.

2. The center apparatus according to claim 1, wherein
the processor is further configured to execute the one or more instructions to acquire the control information further including store specification information for specifying the store in which the content is displayed.

3. The center apparatus according to claim 1, wherein
the processor is further configured to execute the one or more instructions to acquire the control information further including a display condition in which the content is displayed on the display terminal specified by the display terminal specification information.

4. The center apparatus according to claim 1, wherein
the display terminal is an electronic shelf label,
a plurality of the electronic shelf labels are installed in association with each of a plurality of products in the store, and
the display terminal specification information includes, as information for specifying the display terminal, information for identifying the associated product.

5. The center apparatus according to claim 1, wherein
the display terminal specification information includes, as information for specifying the display terminal, information indicating an installation position in the store.

6. The center apparatus according to claim 1, wherein
the processor is further configured to execute the one or more instructions to compute a usage fee of the display terminal to be charged to a manufacturer according to a display control content of the display terminal based on the control information.

7. A store apparatus comprising:
at least one memory configured to store one or more instructions; and
at least one processor configured to execute the one or more instructions to:
acquire, from the center apparatus according to claim 1, control information including display terminal specification information for specifying at least one of display terminals installed in a store, and content information for specifying a content to be displayed on the specified display terminal; and
control display of the display terminal installed in the store, based on the control information.

8. (canceled)

9. A processing method for a center apparatus, comprising,
by a center apparatus:
acquiring, from an external terminal, authentication information including manufacturer identification information, and performing authentication based on the authentication information;
in a case where the authentication is successful, acquiring, from the external terminal, control information including display terminal specification information for specifying at least one of display terminals installed in a store, and content information for specifying a content to be displayed on the specified display terminal; and
outputting information indicating the control information according to the control information.

10. (canceled)
